(19) United States
(12) Patent Application Publication
(10) Pub. No.: US 2015/0317871 A1
(43) Pub. Date: Nov. 5, 2015

(54) GAME DEVICE

(71) Applicant: NOVOMATIC AG, Gumpoldskirchen (AT)

(72) Inventors: Johann F. Graf, Gumpoldskirchen (AT); Marek Gawel, Gumpoldskirchen (AT); Benjamin Gutmann, Gumpoldskirchen (AT)

(21) Appl. No.: 14/651,425

(22) PCT Filed: Dec. 10, 2013
(86) PCT No.: PCT/EP2013/076145

§ 371 Date: Jun. 11, 2015

(30) Foreign Application Priority Data
Dec. 11, 2012 (AT) A50575/2012

(51) Int. Cl. G07F 17/32

(52) U.S. Cl. CPC G07F 17/3223; G07F 17/3297

(57) ABSTRACT

Gaming device with a firing mechanism for shooting a game coin into a coin track, comprising a preferably arc-shaped deflection track and leading to a target device, wherein the deflection track is bordered by a recess in a housing front panel and the target device is arranged in the area of said recess, characterised in that the housing front panel is at least sectionally transparent in design, wherein behind the housing front panel, a visualisation device is arranged such that at least a portion of the visualisation device is visible through the housing front panel and/or through the recess.

The present invention concerns a gaming device with a firing mechanism for shooting a game coin into a coin track comprising a preferably arc-shaped deflection track and leading to a target device, wherein the deflection track is bordered by a recess in a housing front panel and the target device is arranged in the area of said recess.

A gaming device of this kind is known from DE 87 06 212 U1. The deflection track is of circular design in this specification, such that depending on the velocity with which the game coin is shot in, the latter drops sooner or later from an overhead section of the circular track and subsequently continues to travel along a parabolic trajectory or a ballistic trajectory. The target device comprises a crown open towards the top, having several juxtaposed target channels, so that depending on the velocity with which the coin is shot in, the latter falls into one of the target channels or areas, or next to the target device.

Different types of coin such as chips, tokens or genuine currency may serve as game coins.

The firing mechanism may in this case be mechanical in design, comprising for example a spring mechanism and/or a manually operated clamping or rocking lever, but may also be designed otherwise, comprising for example a gas pressure mechanism, whereby the design is preferably constructed such that provision is made for adequate dispersion of the firing force and/or the firing velocity and/or the firing pulse in order to achieve different trajectories and hitting of different target areas.

The problem therefore underlying the present invention is to develop an improved gaming device of the aforementioned type that avoids disadvantages of the state of the art and further develops the latter in an advantageous manner. In particular, a control or monitoring capability of the gaming device is to be extended and an ergonomically convenient display of information that is fatigue-free for the user is to be achieved, without sacrificing a compact device construction.

The problem is solved according to the invention by a gaming device according to claim 1. Preferred embodiments of the invention are the subject of the dependent claims.

It is thus proposed to use a preferably electronic visualisation device such as a screen in order to display the information and thereby arrange the housing front panel having the recess for the game coin deflection track at least partially overlapping said visualisation device, such that the visualisation device or at least a part of the visualisation device is visible through a transparent section of the housing front panel and/or through the recess in said housing front panel. According to the invention, said housing front panel is at least sectionally transparent in design, wherein behind the housing front panel, at least one visualisation device is arranged such that at least a portion of the visualisation device is visible through the housing front panel. Alternatively or additionally according to the invention, at least one visualisation device may be arranged behind the housing front panel such that at least a portion of the visualisation device is visible through the recess in the housing front panel.

This now creates the possibility of being able to display various information on the gaming device, for instance game instructions that explain operation of the device to the device user. Alternatively or additionally, it may be useful to display other information on additional display interfaces, such as advertising or also other games such as additional games or bonus games in order to enhance the entertainment value of the device.

Up to now, solutions for display of such information on the aforementioned devices have been unsatisfactory. As a result of the cutout in the housing front panel provided for the coin track and deflection track and the target device bordered by the same, a central area of the gaming device front is taken up for the coin game, so that display of said information is displaced to the edge of the device. On the one hand, the user's concentration on the actual coin-tossing or coin-shooting game is impaired; on the other hand, it is tiring for the device user to glance back and forth between the coin-tossing game and the display of such information, as the eyes need to look back and forth accordingly in this case.

According to the invention, improved visibility of the information displayed on the visualisation device can now also be advantageously achieved even during a coin shot by means of the staggered or superimposed arrangement of the housing front panel and the display interface of the visualisation device displaying the desired information. Furthermore, the gaming device is characterised by improved ergonomics and ease of use, as a device user experiences less fatigue and needs to look back and forth less with his/her eyes, since the visualisation device and the coin track and the target device are in immediate proximity to one another and can be arranged in a viewing area that offers an easy overview.

A screen in particular, preferably in the form of a flat screen such as an LED screen, LCD screen, plasma screen or TFT monitor may be used as a visualisation device. In principle, other visualisation devices may also be considered, such as for example a mechanical reel-spinning game, comprising for example several reels rotatable around a common axis, or film displays, for example in the form of circulating films or the like. It is preferred however to use a screen of the aforementioned type in order to be able to simply change and brilliantly present the information displayed.

In further embodiment of the invention, provision may be made for extension of the screen directly up to the target device, particularly such that an edge section or a border of the screen and a periphery of the target device are adjacent to each other.

Advantageously, in case of vertical orientation of the gaming device and the housing front panel, the visualisation device may be arranged above the target device, wherein advantageously a bottom periphery of the visualisation device may extend adjacent to a top periphery of the target device.

Alternatively or additionally, provision may also be made for superimposition of the target device and the visualisation device, particularly in such a way that at least a portion of the target device, when the gaming device is observed as intended, is arranged in front of at least a portion of the visualisation device. Advantageously, the target device may in this case be at least sectionally transparent in design, so that at least a section of the visualisation device is visible through the target device. In particular, an information-displaying portion of the visualisation device, particularly of the screen, may be visible through the target device.

According to an advantageous embodiment of the invention, the visualisation device may comprise a screen extending over a wide area of the essentially entire housing front section above the target device, i.e. the entire housing front above the target device may be used as a display interface for presenting the elements of information, including the recess section for coin tossing located at this position and the adjacent, non-recessed housing front panel.

In further embodiment of the invention, the recess in the housing front panel bordering the deflection track may be covered in the direction of the inside of the device by a partition, which is of at least partially transparent design in the area of said recess, so that a section of the visualisation device arranged behind the partition is visible through the partition from the device operating terminal or the operating position. Said partition may in this case between arranged between the housing front panel having the recess and the visualisation device or the screen, particularly such that the housing front panel, the partition and the visualisation device or the screen are superimposed in sandwich fashion.

Alternatively or additionally, the visualisation device or the latter's screen may also itself cover or close on the back panel side or rear side of the device at least a section of the recess of the housing front panel bordering the deflection track, particularly such that the housing front panel in which the recess is formed, is positioned directly on the visualisation device, particularly on the screen, so that a gap forms in the area of the recess in which the shot-in game coin can adopt its path and is preferably guided and secured against tilting. The spacing between the screen and the housing front panel may be sufficiently small such that said gap formed is only slightly wider than the thickness of the game coins and/or is markedly smaller than a diameter of the game coins.

The aforementioned partition by means of which at least a portion of the recess in the housing front panel is closable may feature at least one coin channel recess, which is connectable to the target device and adjoins the target device and forms a coin track for game coins discharging from the target device. Advantageously, game coins arriving in the target device can be removed from the target device through such a coin channel in the partition, wherein the game coins discharging and emerging through the partition have a motion component perpendicular to the housing front panel featuring the partition and/or the recess.

Said visualisation device may, in a further embodiment of the invention, be activated depending on the coin game, particularly depending on whether a game coin falls in a target area and if different target areas have different values or meanings, the target area in which the game coin falls. In a further embodiment of the invention, a detection device for recording the entry of a game coin into a target area may be provided, wherein a preferably electronic control device activates the display appearing on the visualisation device depending on the signal from the target detection device. Said control device may for example start or award a bonus game on the visualisation device screen when the game coin has fallen into a sufficiently high value target area. Alternatively or additionally, an explanatory instruction for operating the firing mechanism may for example be faded in on the screen when a shot coin lands in a target area. Furthermore, alternatively or additionally, when a hit of the target coin in a target area is recorded, the visualisation device may also solely display the coin game results, for example in the form of the message “hit” or the number of points scored.

Said detection device for recording entry of the game coin into a target area may basically be designed in various different ways, for example in the form of an optical and/or magnetic sensor or one operating on a different principle that is assigned to a respective target area and is capable of recording the approach or passage of a coin. Alternatively or additionally, in an advantageous further embodiment of the invention, the detection device may also be incorporated in said visualisation device, especially if the visualisation device covers on the rear side of the device at least one section of the recess and/or also is located in the area of the target device. In particular, the visualisation device may feature a contact sensor, preferably in the form of a touchscreen sensor, wherein the contact sensor is intended and designed to record the contact of a coin, especially when the latter moves into a target area. In an advantageous further embodiment of the invention, the visualisation device may comprise a touchscreen, extending directly to the target device and covering at the rear the recess in which the coin adopts its trajectory, so that the game coin comes into contact with the touchscreen and the touchscreen sensor is able to record the path of motion and/or position of the game coin.

In order to also be able to make interactive intuitive use of a section of the visualisation device located behind said housing front panel in which the recess is provided, a contact detection device may likewise be allocated to said housing front panel and/or a front window applied in front of the housing front panel, preferably in the form of a touchscreen sensor, in order to record contacts by a device user, tapping with the finger for example and allow their transformation into input commands.

A contact sensing logic can relate the detected contacts, i.e. the game coin contacts and/or the contacts by the device user to elements of information and/or displays on the visualisation device in order to intelligently acquire and implement corresponding input signals.

In order to facilitate allocation of the visualisation device to the coin gaming equipment, particularly during installation and maintenance, provision may be made in an advantageous further embodiment for jointly mounting the visualisation device together with the coin gaming equipment, particularly the latter's target device, on a housing door of the device housing, so that the visualisation device and the coin gaming device can be opened with the device door and in particular can be pivoted open. For this purpose, the housing door may be designed as a flap that can be pivoted open around an upright axis in the manner of a door or upwards around a horizontal transverse axis preferably at the top end of the device door, whereby a relief and/or retaining device in the form of a pneumatic spring may be provided in order to hold the housing door with the components attached to the latter in an open position and assist movement into the open position.

The invention will be explained in further detail below based on a preferred example of embodiment and corresponding drawings. In the drawings:

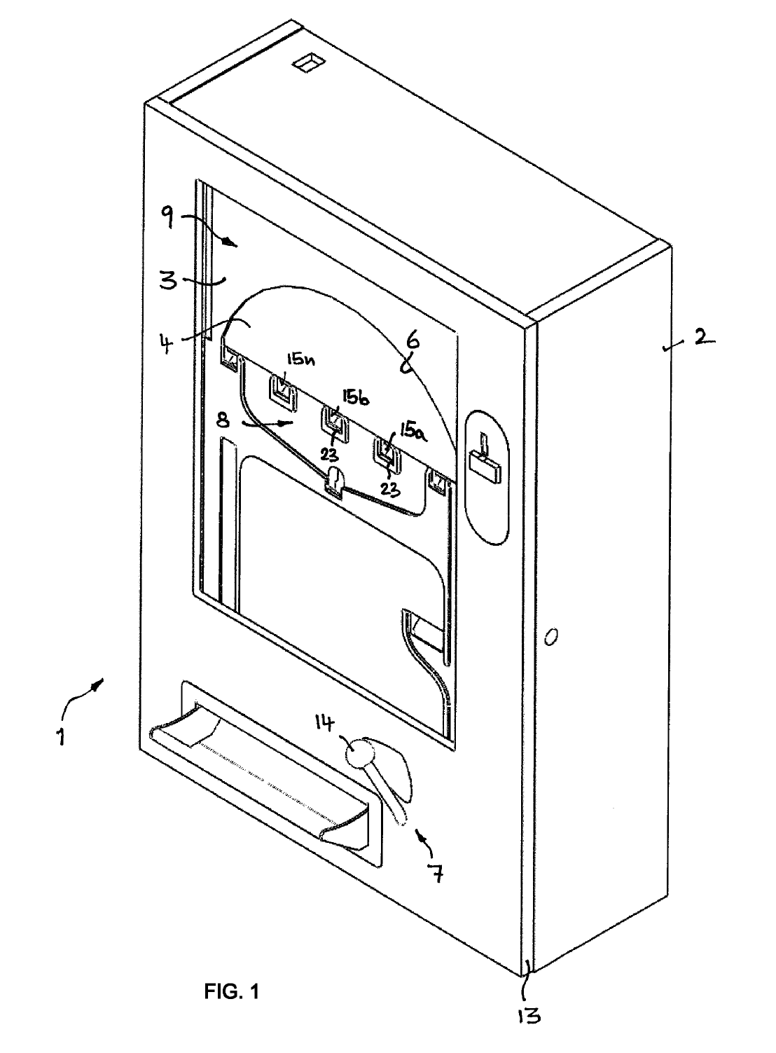

FIG. 1: shows a perspective representation of a gaming device according to a preferred embodiment of the invention, wherein the firing mechanism for shooting a game coin, the coin track bordered by a recess in a housing front panel and the target device likewise arranged in said recess are visible on the device front,

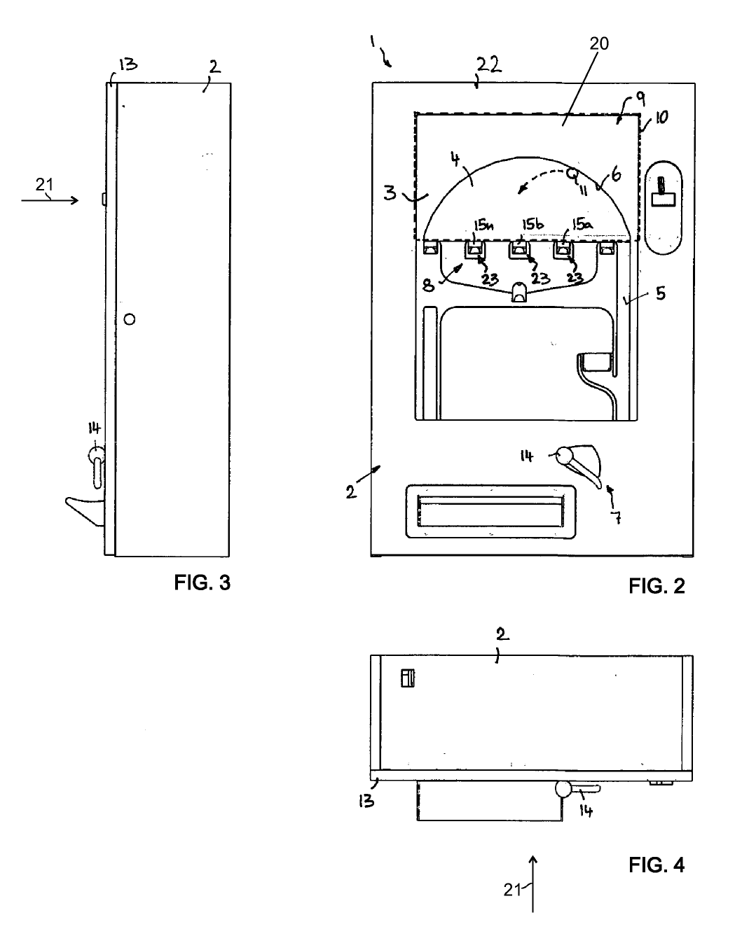

FIG. 2: shows a front view of the gaming device from FIG. 1, which illustrates the arrangement of a screen of the visualisation device partially overlapping said recess and partially overlapping the non-recessed area of the housing front panel,

FIG. 3: shows a side view of the gaming device from the previous figures, which illustrates the cubic design of the device body with the essentially flat design of the housing front, from which an operating lever of the firing mechanism protrudes,

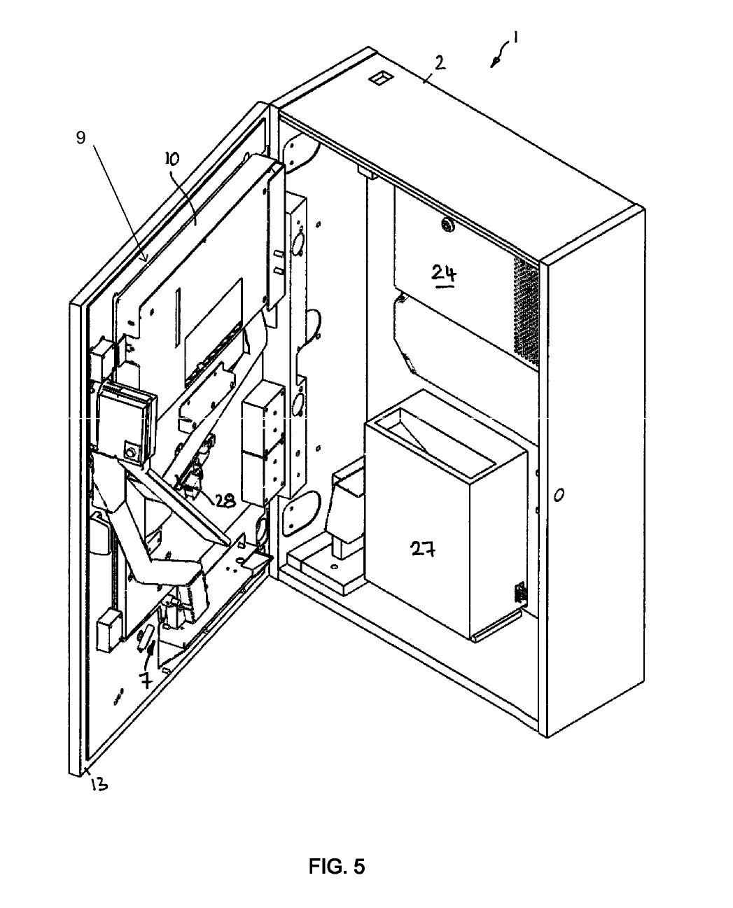

FIG. 4: shows a top view of the top of the gaming device from the previous figures,

FIG. 5: shows a perspective representation of the gaming device from the previous figures with the housing door opened, so that the internal workings of the gaming device and the arrangement of the screen of the visualisation device are visible on the device door.

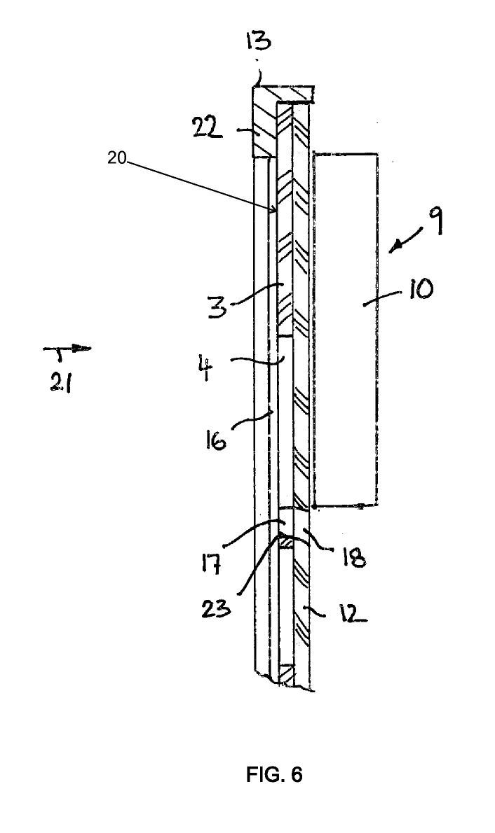

FIG. 6: shows a vertical section through the housing front, which illustrates the staggered arrangement of the housing front panel in which the recess for the coin track is provided, that of the partition closing the recess and that of the screen of the visualisation device and

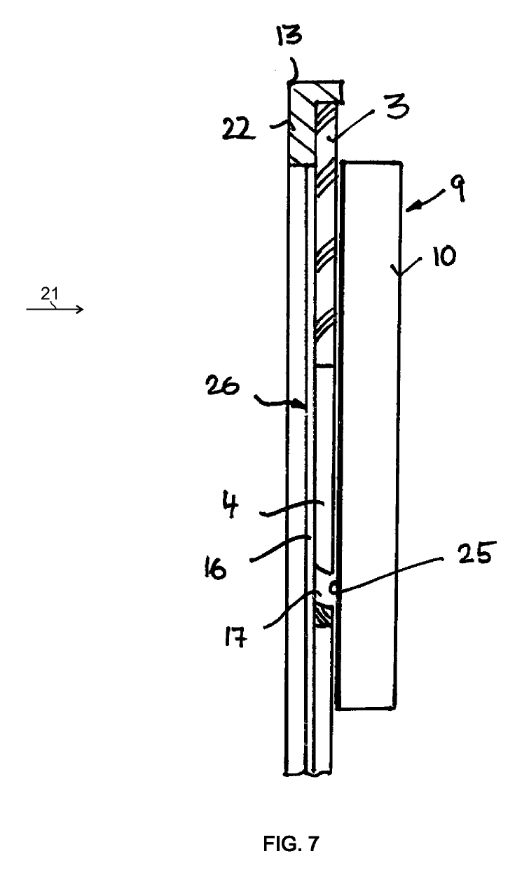

FIG. 7: shows a vertical section through the housing front similar to FIG. 6, wherein the recess for the coin track on the device interior side is directly covered by the screen of the visualisation device, wherein a contact sensor for game coin detection is allocated to the screen and likewise a further contact sensor is allocated to the front window 16 for inputting of interactive control commands by a user.

As FIGS. 1 and 5 show, the gaming device 1 may comprise an essentially cubic device housing 2, which may be advantageously designed in the manner of a cabinet and comprise a housing door 13 in order to be able to open the device housing 2 and render accessible the components accommodated inside the device. Said housing door 13 may in this case form the housing front, which can be essentially viewed frontally from an operating terminal suited to the purpose. The gaming device 1 may be designed as a free-standing, a so-called standalone device, but may also form a wall-mounted device that can be fixed to the wall.

As FIG. 1 shows, a firing mechanism 7 is provided on the housing front or the housing door 13, preferably in a bottom section, of which the operating lever 14 can be seen in FIG. 1. Using said firing mechanism 7, a player can shoot a game coin 11 into a coin track 5, or set the coin in motion, wherein said coin track 5 comprises in the present case an arc-shaped deflection track 6, arranged overhanging or overhead. The game coin 11 is guided along the deflection track 6, for as long as the velocity of the game coin 11 is sufficient, i.e. the game coin 11 is maintained on the deflection path 6 despite counteracting gravitational forces; compare FIG. 2. Depending on the velocity of the game coin 11, the game coin 11 detaches itself at a certain point from the overhanging deflection path 6 in order to subsequently move (under gravitational influence or gravitational pull) along a parabolic curve or trajectory. Depending on the trajectory, the game coin 11 subsequently falls into one of the target areas 15a, 15b, . . . , 15n of a target device 8 or fall in between said target areas 15a, 15b, . . . , 15n. Said target areas 15a, 15b, . . . , 15n may, as illustrated in FIG. 2, be designed in the manner of landing points or islands and/or be arranged spaced apart from one another along a horizontal line underneath said deflection track 6. Alternatively, said target areas 15a, 15b, . . . , 15n may also however be arranged spaced apart from one another along an inclined or vertical line, wherein other arrangements of the target areas are also possible, for example in the form of an irregular, cloud-like distribution of the target areas.

The aforementioned firing mechanism 7 may for example comprise a spring-loaded firing pin, which can be tensioned by the operating lever 14. When the operating lever 14 is released, the game coin 11 is fired under spring force into the coin track 5.

Said deflection path 6 may be bordered by a recess 4 in a housing front panel 3, said front housing panel 3 forming a part of the housing front or a part of the housing door 13. In particular, said recess 4 may comprise an approximately crescent-shaped recess section, the arc-shaped contour of which may itself form said deflection track 6. If necessary, a separate guide that forms the deflection path 6 may be provided in said recess 4, for example in the form of a wire or the like or a guide rail.

As FIG. 4 shows, said housing front panel 3, in which the recess 4 is formed, may be covered at the front by a front window 16, made for example of glass or a transparent plastic, which closes said recess 4. In the direction of the inside of the device, said housing front panel 3 may be covered by a partition 12, wherein the partition 12 likewise extends beyond the recess 4 in order to close the recess 4 in the direction of the inside of the device. The recess 4 forms a disc-shaped or plate-shaped cavity, the thickness of which is slightly greater than the thickness of the game coins, such that the game coins are freely mobile therein, without being able to tip over or only being able to execute slight tilting movements.

The target areas 15 of the target device 8 advantageously extend in the form of collecting baskets or jaws 17 from the partition 12 to said recess 4, wherein the jaws 17 are designed to be open upwards so as to be able to catch game coins 11 dropping from above. In the partition 12, coin channel recesses 18 capable of leading to a coin collector 27 are provided adjoining the jaws 17 to allow game coins 11 landing in the jaws 17 of the target areas 15a, 15b, . . . , 15n to pass through the partition 12 into the coin collector. Alternatively, game coins 11 may also be returned to the firing mechanism 7 via a return channel 28; compare FIG. 5.

As FIGS. 2, 5 and 6 illustrate, a screen 10 of a visualisation device 9 is provided above the target device 8, wherein the screen 10 extends behind the partition 12 and the housing front panel 3 featuring the recess 4, wherein the screen 10 may preferably extend parallel to the housing front panel 3 and partition 12 and in particular directly adjoining the same.

The screen 10 may, according to one embodiment, extend over a wide area essentially over the entire top housing front section, located above the target device, wherein said housing front section may if necessary be bordered by a preferably frame-like or strip-like housing edge 22 in which the visualisation device is recessed.

as FIGS. 2 and 6 show, the screen 10 is positioned in such a manner in this case that a portion of the screen 10 is located behind the recess 4 and another portion of the screen 10 is located behind the non-recessed section 20 of the housing front panel 3. From an operating terminal suited to the purpose, i.e. in a resulting proper viewing direction 21 frontally towards the housing front, the screen 10 is covered by the housing front panel 3 in such a manner that a portion of the screen 10 is visible through the recess 4 and a portion of the screen 10 is visible through the housing front panel 3.

Said housing front panel 3 and the partition 12 are transparent in design, for example in the form of a glass plate or a transparent plastic plate, which may be of anti-glare design in order to avoid reflexes and enhance visibility of the screen.

As FIG. 2 shows, the screen 10 may extend over a wide area essentially over the entire housing front section above the target device 8, wherein said housing front section however is bordered by a non-transparent door frame section 22, extending in the manner of a strip or frame around the screen 10; compare FIG. 2.

As FIG. 2 shows, a bottom edge of the screen 10 in this case may essentially end on a top edge of the target device 8, defined by the target areas 15a, 15b, . . . , 15n. In an alternative embodiment of the invention, the screen 10 could however also extend downwards over the target device 8, so that the screen 10 also overlaps the target device 8. Advantageously, the target device 8 may in this case also be at least partially transparent in design, so that the screen 10 or a section thereof is visible through the target device 8.

Said screen 10 can be activated by a control device 24 incorporated within the housing 2 of the gaming device 1, for example in order to display additional information such as operating instructions, game rules or the like, or also display additional games or bonus games such as for example a reel-spinning game on the screen 10.

In particular, the control device 24 may activate the screen 10 depending on the coin game, in particular depending on whether and which target areas 15a, 15b, . . . , 15n are hit by a game coin 11. For this purpose, a detection device 23, for example in the form of an optical and/or magnetic sensor or one operating on a different principle, may be respectively allocated to said target areas 15a, 15b, . . . , 15n in order to detect entry of a game coin 11 into the respective target area 15a, 15b, . . . , 15n. Depending on the target area hit, a bonus game for example may be started or the number of points scored on the screen 10 may be displayed or other elements of information may be presented, as explained above.

In order to be able to detect and display coin entry into the target areas 15a, 15b, . . . , 15n or also the trajectory adopted by a game coin 11, in a further embodiment of the invention, said detection device 23 may also comprise means of contact detection, preferably in the form of a touchscreen sensor, which may be allocated to the screen 10 or also said partition 12. If the touchscreen sensor is directly allocated to the screen 10, the partition 12 may be omitted and/or the recess 4 and/or the target device 8 may be at least sectionally covered or closed at the rear by the screen 10, so that the game coin 11 on its path through the recess 4 and/or on entry into a target area 15a, 15b, . . . , 15n contacts the screen 10, which is detected by the touchscreen sensor 25. FIG. 7 for example shows a corresponding arrangement of the screen 10. Said touchscreen sensor may be a sensor operating according to the capacitive or inductive principle or according to another principle such as for instance surface wave or infrared optical imaging, in coordination with the game coins used if necessary. The contact sensor may extend over the entire surface of the screen 10 or only over a portion thereof.

In order to facilitate interactive, intuitive control of the gaming device, a contact detection device, preferably in the form of a further contact sensor 26, may alternatively or additionally be allocated to a front window 16 positioned in front (from viewing direction 21) of the housing front panel 3; compare FIG. 7. Said front window 16 may for example be a transparent glass or plastic plate with a contact sensor applied or be designed as a transparent touchscreen. According to an example of embodiment, the control device 24 for controlling the visualisation device 9 and/or for controlling the firing mechanism 7 and/or controlling the target device 8 is intended and designed to depend on detection of contact with the contact detection device 26.

As FIG. 5 shows, the screen 10 and the components of the coin game, particularly the target device 8 and if appropriate also the aforementioned touchscreen facilities, may be jointly positioned on the device door 13, so that said components have a joint mounting base in relation to one another, which facilitates the position assignment of the components in relation to one another. The housing door 13 may form a preassembled module with said components.

The device door 13 may in this case be pivoted open around an upright, lateral axis in the manner of a door and may if necessary be pivoted upwards around a horizontal transverse axis, for example at the top edge of the door, in the manner of a flap, whereby buffering elements and/or relief elements and/or retaining elements for example in the form of a pneumatic spring may be provided in order to hold the device door with the components mounted thereon in an open position and assist movement during travel to this position. An appropriate hinge may be allocated to the lateral axis or the horizontal transverse axis. In an alternative embodiment, the module mentioned above may however be firmly or detachably connected to the device housing 2 without a pivoting function.

1. A gaming device comprising a firing mechanism (7) for shooting a game coin (11) into a coin track (5), wherein said coin track (5) comprises a deflection track (6) and leads to a target device (8), wherein the deflection track (6) is bordered by a recess (4) in a housing front panel (3) and the target device (8) is arranged in the area of the recess (4), characterised in that the housing front panel (3) is at least sectionally transparent in design, wherein behind the housing front panel (3), a visualisation device (9) is arranged such that at least a portion of the visualisation device (9) is visible through the housing front panel (3) and/or through the recess (4).

2. The gaming device according to claim 1, wherein the visualisation device (9) is arranged behind the housing front panel (3) such that a portion of a visualisation device (9) is visible through the at least sectionally transparent housing front panel (3) and another portion of the visualisation device (9) is visible through the recess (4) of the housing front panel (3).

3. The gaming device according to claim 1, wherein the visualisation device (9) extends directly up to the target device (8).

4. The gaming device according to claim 1, wherein the visualisation device (9) extends at least sectionally behind the target device (8), wherein the target device (8) is at least partially transparent in design, so that a portion of the visualisation device (9) is visible through the target device (4).

5. The gaming device according to claim 1, wherein the visualisation device (9) extends over a wide area essentially over the entire top housing front section, located above the target device (8).

6. The gaming device according to claim 1, wherein the recess (4) in the housing front panel (3) is covered in the direction of the inside of the device at least sectionally by a partition (12), which is of at least partially transparent design in the area of the recess (4), so that a section of the visualisation device (9) arranged behind the partition (12) is visible through the partition (12).

7. The gaming device according to claim 6, wherein the partition (12) is arranged in sandwich fashion between the visualisation device (9) and the housing front panel (3).

8. The gaming device according to claim 6 wherein in the partition (12), at least one coin channel recess (18) is provided adjoining the target device (8) and forms a further coin track for game coins (11) discharging from the target device (8).

9. The gaming device according to claim 1, wherein the recess (4) in the housing front panel (3) is covered in the direction of the inside of the device at least sectionally by the visualisation device (9), such that the visualisation device (9) delimits at least a portion of the coin track (5).

10. The gaming device according to claim 1, wherein a detection device (23) for detecting entry of a game coin (11) into a target area (15a, 15b, . . . , 15n) and a control device (24) for controlling the visualisation device (9) are provided depending on the detected target entry of the game coin (11).

11. The gaming device according to claim 10, wherein the detection device (23) comprises a contact detection device allocated to the visualisation device (9), particularly in the form of a touchscreen (25), wherein the contact detection device is intended and designed to detect contact by the game coin (11).

12. The gaming device according to claim 1, wherein a further contact detection device (26) is allocated to the housing front panel (3) and/or a front window (16) positioned in front of the housing front panel (3), wherein the contact detection device (26) is intended and designed to detect manual contacts by a device user.

13. The gaming device according to claim 1, wherein a control device (24) for controlling the visualisation device (9) and/or for controlling the firing mechanism (7) and/or controlling the target device (8) is provided to depend on detection of contact with the contact detection device.

14. The gaming device according to claim 1, wherein the target device (8), the housing front panel (3) and the visualisation device (9) are jointly mounted on a device door (13) and are movable together with the device door (13) in relation to the device body.

15. The gaming device according to claim 5 wherein the housing front section is bordered by a frame-like or strip-like housing edge (22) in which the visualisation device is recessed.
